(19) United States
(12) Patent Application Publication
(10) Pub. No.: US 2014/0147778 A1
(43) Pub. Date: May 29, 2014

(54) TRANSPARENT ELECTROSTATIC CHARGE IMAGE DEVELOPING TONER, ELECTROSTATIC CHARGE IMAGE DEVELOPER, TONER CARTRIDGE, DEVELOPER CARTRIDGE, PROCESS CARTRIDGE, IMAGE FORMING APPARATUS, AND IMAGE FORMING METHOD

(71) Applicant: FUJI XEROX CO., LTD., Tokyo (JP)

(72) Inventors: Tsuyoshi MURAKAMI, Kanagawa (JP); Eisuke IWAZAKI, Kanagawa (JP); Yuki TAKAMIYA, Kanagawa (JP)

(73) Assignee: FUJI XEROX CO., LTD., Tokyo (JP)

(21) Appl. No.: 13/859,310

(22) Filed: Apr. 9, 2013

(30) Foreign Application Priority Data
Nov. 29, 2012 (JP) 2012-260572

(51) Int. Cl. G03G 9/00; G03G 15/08

(52) U.S. Cl. CPC G03G 9/08755
USPC 430/105; 430/108.21; 399/252

(57) ABSTRACT

A transparent electrostatic charge image developing toner includes a binder resin and a compound represented by the following Formula (1):

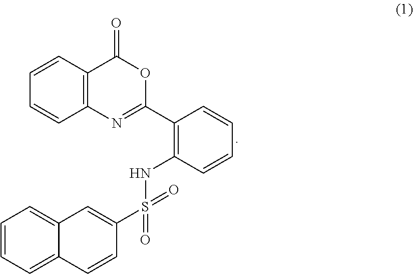 [SMILES: O=c1oc(-c2ccccc2NS(=O)(=O)c2ccc3ccccc3c2)nc2ccccc12]

### CROSS-REFERENCE TO RELATED APPLICATIONS

This application is based on and claims priority under 35 USC 119 from Japanese Patent Application No. 2012-260572 filed Nov. 29, 2012.

### BACKGROUND

1. Technical Field

The present invention relates to a transparent electrostatic charge image developing toner, an electrostatic charge image developer, a toner cartridge, a developer cartridge, a process cartridge, an image forming apparatus, and an image forming method.

2. Related Art

Currently, various fields use a method of visualizing image information through an electrostatic charge image using electrophotography or the like.

In the related electrophotography, a method of performing visualization through plural processes of forming an electrostatic latent image on a photoreceptor or an electrostatic recording member using various sections; developing the electrostatic latent image (toner image) by adhering voltage-detection particles that are referred to as a toner to the electrostatic latent image; transferring the toner image onto a surface of a transfer member; and fixing the toner image by heating or the like is generally used.

In recent years, a toner that emits light due to ultraviolet light has been reported.

### SUMMARY

According to an aspect of the invention, there is provided a transparent electrostatic charge image developing toner including a binder resin and a compound represented by the following Formula (1):

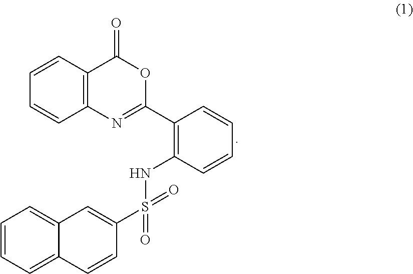 [SMILES: O=c1oc(-c2ccccc2NS(=O)(=O)c2ccc3ccccc3c2)nc2ccccc12]

### BRIEF DESCRIPTION OF THE DRAWINGS

Exemplary embodiments of the present invention will be described in detail based on the following figures, wherein:

FIG. 1 is a schematic diagram showing the configuration of an example of an image forming apparatus that is favorably used in the exemplary embodiment; and

FIG. 2 is a schematic diagram showing the configuration of an example of a process cartridge that is favorably used in the exemplary embodiment.

### DETAILED DESCRIPTION

Electrostatic Charge Image Developing Toner

An electrostatic charge image developing toner (hereinafter, also simply referred to as “toner” or “transparent toner”) of an exemplary embodiment contains a binder resin and a compound represented by the following Formula (1).

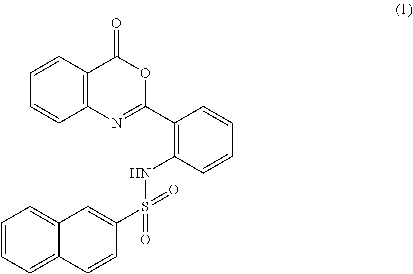 [SMILES: O=c1oc(-c2ccccc2NS(=O)(=O)c2ccc3ccccc3c2)nc2ccccc12]

In this exemplary embodiment, “X to Y” represents a range including not only a range between X and Y, but also X and Y at both ends of the range. For example, when “X to Y” is a numerical value range, it represents “equal to or greater than X and equal to or less than Y” or “equal to or greater than Y and equal to or less than X” in accordance with the sizes of the numerical values.

In this exemplary embodiment, “transparent electrostatic charge image developing toner” means that, regardless of the color of the toner itself, an obtained image is transparent in a visible light range. That is, the toner itself may be white, or slightly tinged with yellow, blue or the like, but an image after fixing is transparent in a visible light range (wavelength of about 400 nm to about 800 nm). “Transparent in a visible light range” means that the transmittance of light of a visible region is 10% or greater, and the transmittance is more preferably 75% or greater. The transmittance is preferably measured by making an image that is the same as that in the measurement of light emission luminance in examples. The transparent toner of this exemplary embodiment means a toner that does not contain a colored colorant (color pigment, color dye, black carbon particles, black magnetic powder, and the like) designed for coloring due to visible light absorption and visible light scattering, or a toner that contains a very small amount of a colored colorant so that coloring due to visible light absorption and visible light scattering is not perceived by the naked eye. Accordingly, the transparent electrostatic charge image developing toner of this exemplary embodiment is preferably a transparent toner having no color although transparency may be slightly reduced in accordance with the types, amounts, and the like of the various components contained in the toner.

In recent years, since an electrophotographic system in which printouts may be made on demand has been used in a commercial printing field, it is required that images having a special effect that have been obtained in a conventional printing field be obtained by electrophotography. As an example thereof, there are images that have no color and are transparent under normal visible light, but emit certain visible wavelengths, i.e., fluorescence under ultraviolet light, e.g., black light irradiation.

Since the images are difficult to reproduce by normal copying, these are used in authenticity determination for preventing forgery, or used when making an image change effect by irradiation with black light (ultraviolet light). In any of the cases, it is preferable to allow easy visual determination of the authenticity, or make it possible to generate a clear image change, and thus a coloring material to be used is required to emit sharp fluorescence. Examples of the coloring material that emits sharp fluorescence include organic fluorescent materials formed of an organic material. However, on the principle that the light is emitted by excitation in molecules, these have difficulty in maintaining the structure for a long time, and thus have poor light fastness.

The inventors of the invention have conducted intensive study and as a result, found that when a compound represented by Formula (1) is used, a sharp image that emits strong fluorescence in a region of from green to yellow-green is obtained. In addition, it has been found that the compound represented by Formula (1) has excellent light fastness, as compared with fluorescence colorants in the related art.

The compound represented by Formula (1) has a peak wavelength of absorption in a UV-A region of around 360 nm, absorbs ultraviolet light of this region, and emits strong fluorescence. Meanwhile, natural light such as sunlight also includes ultraviolet light of a so-called UV-B region of 315 nm or less. It has been found that such ultraviolet light of the UV-B region does not greatly contribute to the emission of fluorescence, and also breaks down the molecular structure of the compound represented by Formula (1). The detailed action mechanism thereof is not clear, but it is presumed that a radical is generated due to ultraviolet light of the UV-B region, and thus the molecular structure is broken down.

The inventors of the invention have conducted intensive study and as a result, found that when a polyester resin in which a wavelength at which absorbance is 2.0 or greater is 280 nm to 320 nm in scanning from a long wavelength to a short wavelength is used as a binder resin, the light fastness is remarkably improved. It is presumed that the binder resin, when present around the compound represented by Formula (1), suppresses light of the UV-B region, that causes a reduction in light fastness reaching the compound represented by Formula (1), and improves the light fastness.

Hereinafter, the components of the toner will be described in detail.

Compound Represented by Formula (1)

The toner of this exemplary embodiment is required to contain the compound represented by Formula (1). When the compound represented by Formula (1) is contained, images that are sharp under ultraviolet light are obtained, and images that have excellent light fastness as compared with fluorescent materials in the related art, and are sharp for a long time are obtained.

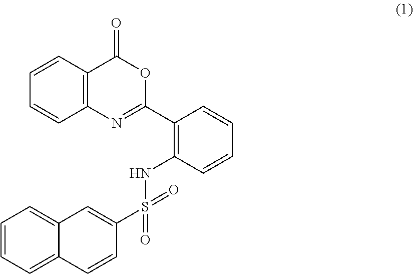 [SMILES: O=c1oc(-c2ccccc2NS(=O)(=O)c2ccc3ccccc3c2)nc2ccccc12]

The compound represented by Formula (1) may be synthesized by a known method. For example, it may be synthesized using the method described in JP-A-8-104867.

In addition, the compound represented by Formula (1) has been placed on the market and may be obtained as CARTAX CXDP (manufactured by Clariant).

In this exemplary embodiment, the content of the compound represented by Formula (1) in the toner is preferably from 2% by weight to 10% by weight, more preferably from 3% by weight to 8% by weight, and even more preferably from 4% by weight to 6% by weight in the entire toner.

When the content of the compound represented by Formula (1) is in the above range, transparency under visible light is excellent, and a sharp image having a high emission intensity is obtained.

In this exemplary embodiment, in the case of a toner in which an external additive is added to toner base particles, “entire toner” means a combination of the toner base particles and the external additive.

Binder Resin

The toner contains a binder resin.

In this exemplary embodiment, as the binder resin, a polycondensation resin is preferably contained, and a polyester resin is particularly preferably contained. A polyester resin is preferably used, because the compound represented by Formula (1) may be incorporated into toner base particles in a more uniform state.

Polycondensation Resin

Preferable examples of the polycondensation resin include a polyester resin and a polyamide resin, and a polyester resin that is obtained using a material containing a polycarboxylic acid and polyol as polycondensable monomers is particularly preferably used.

Examples of the polycondensable monomer that may be used in this exemplary embodiment include polyvalent carboxylic acids, polyols, hydroxycarboxylic acids, polyamines, and mixtures thereof. Particularly, as the polycondensable monomer, polyvalent carboxylic acids, polyols, and ester compounds thereof (oligomers and/or prepolymers) are preferably used, and a polyester resin may be obtained preferably through a direct ester reaction or an ester exchange reaction. In this case, the polyester resin to be polymerized may employ any form such as an amorphous polyester resin (also referred to as an amorphous polyester resin) and a crystalline polyester resin, or a mixed form thereof.

In this exemplary embodiment, the polycondensation resin is obtained by polycondensing at least one type that is selected from the group consisting of polycondensable monomers and oligomers and prepolymers thereof. Among them, polycondensable monomers are preferably used.

The polyvalent carboxylic acid is a compound containing two or more carboxyl groups in a molecule. Among polyvalent carboxylic acids, a dicarboxylic acid is a compound containing two carboxyl groups in a molecule, and examples thereof include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

In addition, examples of polyvalent carboxylic acids other than dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, n-octenylsuccinic acid, and lower esters thereof, as well as acid halides and acid anhydrides thereof.

These may be used singly or in combination of two or more types.

The lower esters are esters in which the alkoxy part of the ester has 1 to 8 carbon atoms. Specific examples thereof include methyl esters, ethyl esters, n-propyl esters, isopropyl esters, n-butyl esters, and isobutyl esters.

The polyol is a compound containing two or more hydroxyl groups in a molecule. Among polyols, a diol is a compound containing two hydroxyl groups in a molecule, and specific examples of the diol include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol-A, bisphenol-A, bisphenol-F, bisphenol-S, and alkylene oxide (ethylene oxide, propylene oxide, butylene oxide, and the like) adducts of the above bisphenols. Among them, alkylene glycols having 2 to 12 carbon atoms and alkylene oxide adducts of bisphenols are preferably used, and alkylene oxide adducts of bisphenols and combinations of alkylene glycols having 2 to 12 carbon atoms with the alkylene oxide adducts of bisphenols are particularly preferably used.

For higher water dispersibility, 2,2-dimethylol propionic acid, 2,2-dimethylol butanoic acid, and 2,2-dimethylol valeric acid are further exemplified.

Examples of tri- or higher-valent alcohols include glycerin, trimethylolethane, trimethylolpropane, pentaerythritol, hexamethylol melamine, hexaethylol melamine, tetramethylol benzoguanamine, tetraethylol benzoguanamine, sorbitol, trisphenol PA, phenol novolacs, cresol novolacs, and alkylene oxide adducts of the tri- or higher-valent polyphenols. These may be used singly or in a combination of two or more types.

In addition, an amorphous resin and a crystalline resin may be easily obtained by combination of the polycondensable monomers.

When a crystalline polyester resin is used as the binder resin, examples of the crystalline polyester resin include polyester that is obtained by reacting 1,9-nonanediol with a 1,10-decanedicarboxylic acid, or reacting cyclohexanediol with an adipic acid, polyester that is obtained by reacting 1,6-hexanediol with a sebacic acid, polyester that is obtained by reacting ethylene glycol with a succinic acid, polyester that is obtained by reacting ethylene glycol with a sebacic acid, and polyester that is obtained by reacting 1,4-butanediol with a succinic acid. Among them, polyester that is obtained by reacting 1,9-nonanediol with a 1,10-decanedicarboxylic acid, polyester that is obtained by reacting 1,6-hexanediol with a sebacic acid, and the like are particularly preferably used, but the examples are not limited thereto.

In addition, a hydroxycarboxylic acid may also be used. Specific examples of the hydroxycarboxylic acid include hydroxyheptanoic acid, hydroxyoctanoic acid, hydroxydecanoic acid, hydroxyundecanoic acid, malic acid, tartaric acid, mucic acid, and citric acid.

In addition, examples of polyamine include ethylenediamine, diethylenediamine, 1,2-propanediamine, 1,3-propanediamine, 1,4-butanediamine, 1,4-butenediamine, 2,2-dimethyl-1,3-butanediamine, 1,5-pentanediamine, 1,6-hexanediamine, 1,4-cyclohexanediamine, and 1,4-cyclohexanebis(methylamine).

In addition, the weight average molecular weight of the polycondensation resin that is obtained by polycondensation of polycondensable monomers is preferably from 1,500 to 40,000, and more preferably from 3,000 to 30,000. The weight average molecular weight is preferably 1,500 or greater, because the cohesive force of the binder resin becomes favorable and an excellent hot offset property is obtained. The weight average molecular weight is preferably 40,000 or less, because an excellent hot offset property is obtained and a minimum fixing temperature exhibits an excellent value. In addition, partial branching, cross-linking and the like may be provided by selection of valence of carboxylic acid of the monomer and alcohol valence.

In addition, the acid value of the obtained polyester resin is preferably from 1 mg·KOH/g to 50 mg·KOH/g. A first reason is that the toner particle size and the distribution in an aqueous medium are required to be controlled for practical use as a high-image quality toner, and when the acid value is 1 mg·KOH/g or greater, a sufficient particle size and distribution may be achieved in the granulation process. Furthermore, a sufficient chargeability may be obtained when the polyester resin is used in the toner. When the acid value of polyester to be polycondensed is 50 mg·KOH/g or less, a sufficient molecular weight for obtaining an image quality strength for the toner may be obtained in the polycondensation. In addition, the dependence of the chargeability of the toner on environment at high humidity is also reduced and excellent image reliability is obtained.

When an amorphous polyester resin is used, the glass transition temperature Tg of the amorphous polyester resin is preferably from 50° C. to 80° C., and more preferably from 50° C. to 65° C. When Tg is 50° C. or higher, the binder resin itself in a high-temperature region has an excellent cohesive force, and thus the hot offset property is excellent in fixing. In addition, when Tg is 80° C. or lower, melting is carried out sufficiently and the minimum fixing temperature does not rise easily.

The glass transition temperature of the binder resin is a value measured using a method (DSC method) specified in ASTM D3418-82.

Specific Polyester Resin

In this exemplary embodiment, the binder resin preferably contains a polyester resin (in this exemplary embodiment, also referred to as “specific polyester resin”) in which a wavelength at which absorbance is 2.0 or greater in scanning from a long wavelength to a short wavelength in an ultraviolet absorption spectrum is from 280 nm to 320 nm.

Specifically, the binder resin is dissolved in acrylonitrile so as to be at 1,000 ppm, and the measurement is performed with an optical path length of 1 cm under conditions of a start wavelength of 500 nm, an end wavelength of 200 nm, a scanning speed of 300 nm/min, and a slit of 2 nm. At this time, as for the specific polyester resin, the wavelength at which absorbance is 2.0 or greater is from 280 nm to 320 nm. Acrylonitrile is preferably used as a solvent. However, when the solubility of the binder resin is low, a solvent may be appropriately selected from various solvents that are usable in the ultraviolet region, and is not particularly limited.

When the wavelength at which the absorbance is 2.0 or greater is 320 nm or less, the absorbance of the light in a wavelength region that is absorbed by the compound represented by Formula (1) is weak, and thus a sharp image emitting strong fluorescence is obtained. In addition, when the wavelength at which the absorbance is 2.0 or greater is 280 nm or greater, an effect of improving the light fastness of the compound represented by Formula (1) is obtained.

In the specific polyester resin, the wavelength at which the absorbance is 2.0 or greater in scanning from a long wavelength to a short wavelength in an ultraviolet absorption spectrum is preferably from 285 nm to 315 nm, and more preferably from 290 nm to 310 nm.

The specific polyester resin may be any of a crystalline polyester resin and an amorphous polyester resin, and is not particularly limited. However, the specific polyester resin is preferably an amorphous polyester resin from the viewpoint of easily obtaining a polyester resin having desired characteristics.

By controlling the content of an ethylenic unsaturated bond in the resin, the wavelength at which the absorbance is 2.0 or greater in scanning from a long wavelength to a short wavelength in an ultraviolet absorption spectrum may be from 280 nm to 320 nm. Particularly, a polyester resin having the above-described characteristics is obtained by controlling the amount of an ethylenic unsaturated bond (double bond) included in a main chain of the polyester resin to an appropriate amount. This principle is not clear, but is presumed as follows.

That is, a part in which ethylenic unsaturated bonds (double bonds) are regularly arranged in the main chain of the polyester resin acts as a conjugate system, and the absorbance wavelength shifts to the long wavelength side. In the case of a resin in which there are a large number of such parts, the absorption shifts to the longer wavelength side, and, on the other hand, in the case of a resin in which there are few such parts, absorption is shown on the short wavelength side.

Accordingly, it is preferable to synthesize a polyester resin using an unsaturated polyvalent carboxylic acid such as maleic acid, fumaric acid, citraconic acid, mesaconic acid, and glutaconic acid, or an alkenediol, specifically an unsaturated polyol such as 2-butyne-1,4-diol, 3-butyne-1,4-diol, and 9-octadecene-7,12-diol.

In this exemplary embodiment, the content of the specific polyester resin in the toner is preferably from 10% by weight to 90% by weight, more preferably from 30% by weight to 85% by weight, and even more preferably from 50% by weight to 80% by weight with respect to the total weight of the toner.

In addition, the content of the specific polyester resin with respect to the total amount of the binder resin is preferably 30% by weight of greater, more preferably 50% by weight or greater, and even more preferably 70% by weight or greater, and it is particularly preferable that the specific polyester resin occupy the total amount of the binder resin.

Addition Polymerization-Type Resin

In this exemplary embodiment, an addition polymerization-type resin may be used as the binder resin.

As an addition polymerizable monomer that is used in the preparation of the addition polymerization-type resin, a cationic polymerizable monomer and a radical polymerizable monomer are exemplified, and a radical polymerizable monomer is preferably used.

Examples of the radical polymerizable monomer include styrene-based monomers, unsaturated carboxylic acids, (meth)acrylates (“(meth)acrylates” means acrylates and methacrylates, and has the same usage below), N-vinyl compounds, vinyl esters, halogenated vinyl compounds, N-substituted unsaturated amides, conjugated dienes, multifunctional vinyl compounds, and multifunctional (meth)acrylates. Among them, N-substituted unsaturated amides, conjugated dienes, multifunctional vinyl compounds, multifunctional (meth)acrylates and the like may also cause a cross-linking reaction to the generated polymer. These may be used singly or in combination.

Examples of the addition polymerizable monomer that may be used in this exemplary embodiment include a radical polymerizable monomer, a cationic polymerizable monomer, and an anionic polymerizable monomer, and a radical polymerizable monomer is preferably used.

As the radical polymerizable monomer, a compound having an ethylenic unsaturated bond is preferably used, and an aromatic ethylenic unsaturated compound (hereinafter, also referred to as “vinyl aromatic”), a carboxylic acid having an ethylenic unsaturated bond (unsaturated carboxylic acid), a derivative of an unsaturated carboxylic acid, such as ester, aldehyde, nitrile or amide, a N-vinyl compound, vinyl esters, a halogenated vinyl compound, a N-substituted unsaturated amide, conjugated diene, a multifunctional vinyl compound, or multifunctional (meth)acrylate is more preferably used.

Specific examples thereof include unsubstituted vinyl aromatics such as styrene and p-vinylpyridine, vinyl aromatics such as α-substituted styrenes, e.g., α-methylstyrene and α-ethylstyrene, aromatic nucleus-substituted styrenes, e.g., m-methylstyrene, p-methylstyrene and 2,5-dimethylstyrene, and aromatic-nucleus halogen-substituted styrenes, e.g., p-chlorostyrene, p-bromostyrene, and dibromostyrene, unsaturated carboxylic acids such as (meth)acrylic acid (“(meth)acryl” means acryl and methacryl, and has the same usage below), crotonic acid, maleic acid, fumaric acid, citraconic acid, and itaconic acid, unsaturated carboxylic acid esters such as methyl(meth)acrylate, ethyl(meth)acrylate, propyl(meth)acrylate, butyl(meth)acrylate, pentyl(meth)acrylate, hexyl(meth)acrylate, 2-ethylhexyl(meth)acrylate, glycidyl(meth)acrylate, and benzyl(meth)acrylate, unsaturated carboxylic acid derivatives such as (meth)acrylic aldehyde, (meth)acrylonitrile and (meth)acrylamide, N-vinyl compounds such as N-vinylpyridine and N-vinylpyrrolidone, vinyl esters such as vinyl formate, vinyl acetate, and vinyl propionate, halogenated vinyl compounds such as vinyl chloride, vinyl bromide, and vinylidene chloride, N-substituted unsaturated amides such as N-methylolacrylamide, N-ethylolacrylamide, N-propanolacrylamide, N-methylolmaleinamic acid, N-methylolmaleinamic acid ester, N-methylolmaleimide, and N-ethylolmaleimide, conjugated dienes such as butadiene and isoprene, multifunctional vinyl compounds such as divinylbenzene, divinylnaphthalene, and divinylcyclohexane, and multifunctional acrylates such as ethylene glycol di(meth)acrylate, diethylene glycol di(meth)acrylate, propylene glycol di(meth)acrylate, tetramethylene glycol di(meth)acrylate, neopentyl glycol di(meth)acrylate, hexamethylene glycol di(meth)acrylate, trimethylolpropane di(meth)acrylate, trimethylolpropane tri(meth)acrylate, glycerol di(meth)acrylate, glycerol tri(meth)acrylate, pentaerythritol di(meth)acrylate, pentaerythritol tri(meth)acrylate, pentaerythritol tetra(meth)acrylate, dipentaerythritol di(meth)acrylate, dipentaerythritol tri(meth)acrylate, dipentaerythritol tetra(meth)acrylate, dipentaerythritol penta(meth)acrylate, dipentaerythritol hexa(meth)acrylate, sorbitol tri(meth)acrylate, sorbitol tetra(meth)acrylate, sorbitol penta(meth)acrylate and sorbitol hexa(meth)acrylate. In addition, a sulfonic acid and a phosphonic acid having an ethylenic unsaturated bond, and derivatives thereof may also be used. Among them, N-substituted unsaturated amides, conjugated dienes, multifunctional vinyl compounds, multifunctional acrylates and the like may cause a cross-linking reaction to the generated polymer. The addition polymerizable monomers may be used singly or in combination of two or more types.

In addition, the content of the binder resin in the toner of this exemplary embodiment is preferably from 10% by weight to 90% by weight, more preferably from 30% by weight to 85% by weight, and even more preferably from 50% by weight to 80% by weight with respect to the total weight of the toner.

Release Agent

The electrostatic charge image developing toner of this exemplary embodiment preferably contains a release agent.

For example, ester wax, polyethylene, polypropylene, or a copolymer of polyethylene and polypropylene is preferably used as the release agent, and specific examples thereof include waxes such as polyglycerin wax, microcrystalline wax, paraffin wax, carnauba wax, Sasol wax, montanic acid ester wax, and deoxidized carnauba wax; unsaturated fatty acids such as palmitic acid, stearic acid, montanic acid, brassidic acid, eleostearic acid, and parinaric acid; saturated alcohols such as stearyl alcohol, aralkyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, and N,N′-dioleylsebacic acid amide; aromatic bisamides such as m-xylenebisstearic acid amide and N,N′-distearylisophthalic acid amide; fatty acid metal salts (generally so-called metal soaps) such as calcium stearate, calcium laurate, zinc stearate, and magnesium stearate; waxes grafted to aliphatic hydrocarbon-based wax using a vinyl-based monomer such as styrene and an acrylic acid; partially esterified products of a fatty acid and polyhydric alcohol such as behenic acid monoglyceride; and methyl ester compounds having a hydroxyl group that is obtained by hydrogenating vegetable oil.

The release agent may be used singly or in combination of two or more types. The release agent is contained in an amount of preferably from 1% by weight to 20% by weight, and more preferably from 3% by weight to 15% by weight with respect to 100% by weight of the binder resin. When the content is in the above range, excellent fixing and image quality characteristics may be balanced.

Other Components

If necessary, various components, such as an internal additive, a charge-controlling agent, an inorganic powder (inorganic particles) and organic particles, other than the above-described components may be added to the toner.

Examples of the internal additive include magnetic materials, such as metals such as ferrite, magnetite, reduced iron, cobalt, nickel, and manganese, alloys and compounds containing the metals. When the toner contains the magnetic material and the like and is used as a magnetic toner, the average particle size of the ferromagnetic materials is preferably 2 μm or less, and more preferably from about 0.1 μm to about 0.5 μm. The amount contained in the toner is preferably from 20 parts by weight to 200 parts by weight with respect to 100 parts by weight of the resin component, and particularly preferably from 40 parts by weight to 150 parts by weight with respect to 100 parts by weight of the resin component. In addition, regarding the magnetic characteristics when 10 KOe is applied, it is preferable that the coercive force (Hc) be from 20 Oe to 300 Oe, the saturated magnetization (σs) be from 50 emu/g to 200 emu/g, and the remnant magnetization (σr) be from 2 emu/g to 20 emu/g.

Examples of the charge-controlling agent include tetrafluorinated surfactants, salicylic acid metal complexes, metal complex dyes such as azo-based metal compounds, polymer acids such as a polymer containing a maleic acid as a monomer component, quaternary ammonium salts, and azine-based dyes such as nigrosine.

External Additive

It is preferable that an external additive be externally added to a surface of the toner. Examples of the external additive that is externally added to the surface include inorganic particles and organic particles. Specifically, other than the following examples, an external additive that is used in a toner manufacturing method to be described later is also included.

Examples of the inorganic particles include silica, alumina, titanium oxide, barium titanate, magnesium titanate, calcium titanate, strontium titanate, zinc oxide, silica sand, clay, mica, wollastonite, diatomaceous earth, cerium chloride, red iron oxide, chromium oxide, cerium oxide, antimony trioxide, magnesium oxide, zirconium oxide, silicon carbide, and silicon nitride.

Generally, inorganic particles are used for the purpose of improving fluidity. The primary particle size of the inorganic particles is preferably from 1 nm to 200 nm, and the amount added is preferably from 0.01 part by weight to 20 parts by weight with respect to 100 parts by weight of the toner.

Generally, organic particles are used for the purpose of improving cleanability and transferability, and specific examples thereof include fluorine-based resin powders such as polyvinylidene fluoride and polytetrafluoroethylene, fatty acid metal salts such as zinc stearate and calcium stearate, polystyrene, and polymethylmethacrylate.

In this exemplary embodiment, it is preferable that an external additive having a number average primary particle size of 18 nm or less or 25 nm or greater be contained as the external additive. In addition, it is preferable that an external additive having a number average primary particle size of greater than 18 nm and less than 25 nm not be contained as the external additive.

The reason for this is not clear, but is likely as follows. When an external additive having a number average primary particle size of greater than 18 nm and less than 25 nm is contained as the external additive, it is observed that blue light is absorbed and the light emission luminance of the toner is reduced under ultraviolet irradiation.

It is more preferable that an external additive having a number average primary particle size of greater than 20 nm and less than 25 nm not be contained as the external additive.

The number average primary particle size of the external additive is obtained as follows. External additive particles are diluted in ethanol and dried on a carbon grid for a transmission electron microscope (TEM: JEM-1010, manufactured by JEOL Ltd.) to perform TEM observation (at a magnification of 50,000 times). The image of TEM observation is printed, and 50 primary particle samples are arbitrarily extracted. The outer diameter of circular particles corresponding to the area of the image (average value of the major axis and the minor axis: obtained with approximation to a circle) is defined as the number average particle size of the external additive.

Among the above-described external additives, inorganic oxides such as titania and silica are preferably used from the viewpoint of improving the fluidity and the charging characteristics.

The amount of the external additive added is preferably from 0.1 part by weight to 5 parts by weight with respect to 100 parts by weight of the toner particles before external addition. When the amount of the external additive is 0.1 part by weight or greater, an improvement in fluidity and chargeability due to the external additive is shown. When the amount of the external additive is 5 parts by weight or less, a sufficient chargeability is provided.

Toner Properties

The toner of this exemplary embodiment preferably has ultraviolet absorptivity. In addition, the toner of this exemplary embodiment preferably absorbs ultraviolet rays and emits fluorescence.

The wavelength of the ultraviolet rays that are absorbed by the toner is preferably from greater than 320 nm and equal to or less than 390 nm, more preferably from 330 nm to 385 nm, even more preferably from 340 nm to 380 nm, and particularly preferably from 350 nm to 370 nm.

In addition, the emission intensity of an image is measured as follows. Using the toner of this exemplary embodiment, a solid image is formed so that a toner amount becomes 4.5 g/m², and the image is subjected to spectral fluorescence measurement using a fluorescence spectrophotometer to perform the evaluation by a light-emission peak intensity.

A volume average particle size Dv (D₅₀ᵥ) of the toner of this exemplary embodiment is preferably from 2 μm to 20 μm, more preferably from 3 μm to 15 μm, and even more preferably from 4 μm to 10 μm.

In addition, a volume average particle size Dv (D₅₀ᵥ) of the toner base particles in the toner of this exemplary embodiment is preferably from 2 μm to 20 μm, more preferably from 3 μm to 15 μm, and even more preferably from 4 μm to 10 μm.

It is preferable that the particle size distribution of the toner be narrow. More specifically, the value (GSDp) of the square root of the ratio of the 84% diameter (D₈₄ₚ) to the 16% diameter (D₁₆ₚ) converted from the smallest number diameter side of the toner, that is, GSDp that is expressed by the following formula is preferably 1.40 or less, more preferably 1.31 or less, and particularly preferably 1.27 or less. In addition, GSDp is even more preferably 1.15 or greater.

GSDp={(D₈₄ₚ)/(D₁₆ₚ)}^{0.5}

When both of the volume average particle size and GSDp are in the above ranges, respectively, excessively small particles are not present, and thus a reduction in developability due to an excessive charge amount of the small-particle-size toner may be suppressed.

In the measurement of the average particle size of toner particles, a Coulter Multisizer II (manufactured by Beckman Coulter, Inc.) may be used. In this case, the measurement may be performed using an optimum aperture depending on the particle size level of the particles. The measured particle size of the particles is expressed as the volume average particle size.

When the particle size of the particles is about 5 or less, the measurement may be performed using a laser diffraction/scattering particle size distribution measuring device (LA-700, manufactured by Horiba, Ltd.).

Furthermore, when the particle size is a nanometer-order size, the measurement may be performed using a BET specific surface area measuring device (Flow Sorb II 2300, manufactured by Shimadzu Corporation).

In this exemplary embodiment, a shape factor SF1 of the toner is preferably from 110 to 145, and more preferably from 120 to 140.

The shape factor SF1 is a shape factor showing the degree of unevenness of the particle surface, and is calculated using the following expression.

$$S F 1 = \frac{{( M L )}^{2}}{A} \times \frac{π}{4} \times 100 \qquad Expression 1$$

In the expression, ML represents the maximum length of the particle, and A represents a projected area of the particle.

As a specific method of measuring the shape factor SF1, for example, first, an optical microscopic image of the toner sprayed on a glass slide is scanned to an image analyzer through a video camera, the shape factors SF1 of 50 toner particles are calculated, and an average value thereof is obtained.

Toner Preparation Method

The toner that is used in this exemplary embodiment is not particularly limited by the manufacturing method, and a known method may be used. Specific examples thereof include the following method.

For manufacturing toner base particles, it is possible to use a kneading pulverization method in which, for example, a binder resin, a compound represented by Formula (1), a release agent and if necessary, a charge-controlling agent and the like are kneaded, pulverized, and classified; a method of changing the shape of particles obtained by the kneading pulverization method with a mechanical impact force or thermal energy; an emulsion aggregation method in which a dispersion obtained by emulsifying and dispersing a binder resin, a compound represented by Formula (1), a release agent, and if necessary, a dispersion of a charge-controlling agent and the like are mixed, aggregated, and fused by heating to obtain toner particles; an emulsion polymerization aggregation method in which a dispersion formed by emulsion-polymerizing a polymerizable monomer of a binder resin, a compound represented by Formula (1), a release agent, and if necessary, a dispersion of a charge-controlling agent and the like are mixed, aggregated, and fused by heating to obtain toner particles; a suspension polymerization method in which a polymerizable monomer for obtaining a binder resin, a compound represented by Formula (1), a release agent, and if necessary, a solution of a charge-controlling agent and the like are suspended in an aqueous solvent and polymerized; or a dissolution suspension method in which a binder resin, a compound represented by Formula (1), a release agent, and if necessary, a solution of a charge-controlling agent and the like are suspended in an aqueous solvent and granulated. In addition, a manufacturing method may be performed in which aggregated particles are adhered to toner base particles as cores obtained by the above-described method, and coalescence is performed by heating to obtain a core shell structure.

Among them, the toner of this exemplary embodiment is preferably a toner that is obtained by the emulsion aggregation method or the emulsion polymerization aggregation method.

In the toner according to this exemplary embodiment, for example, an external additive may be added to and mixed with the obtained toner particles. The mixing is preferably performed by, for example, a V-blender, a Henschel mixer, a Loedige mixer or the like. If necessary, coarse toner particles may be removed using a vibrating sieve, an air classifier, or the like.

Electrostatic Charge Image Developer

An electrostatic charge image developer of this exemplary embodiment (hereinafter, may be referred to as “developer”) is not particularly limited provided it contains the above-described toner of this exemplary embodiment. The electrostatic charge image developer may be a single-component developer using a toner alone, or a two-component developer containing a toner and a carrier. When the electrostatic charge image developer is a single-component developer, it may be a toner containing magnetic metallic particles or a nonmagnetic single-component toner not containing magnetic metallic particles.

The carrier is not particularly limited if it is a known carrier, and an iron powder-based carrier, a ferrite-based carrier, a surface-coated ferrite carrier or the like is used. In addition, each surface addition powder may be used after a desired surface treatment is performed.

Specific examples of the carrier include carriers coated with the following resins. Examples of the nucleus particles of the carrier include a normal iron powder, ferrite, and granulated magnetite, and the volume average particle size thereof is preferably from 30 μm to 200 μm.

In addition, examples of the coating resin of the resin-coated carrier include homopolymers or copolymers made of two or more types of monomers of styrenes such as styrene, parachlorostyrene and α-methylstyrene; α-methylene fatty acid monocarboxylic acids such as methyl acrylate, ethyl acrylate, n-propyl acrylate, lauryl acrylate, 2-ethylhexyl acrylate, methyl methacrylate, n-propyl methacrylate, lauryl methacrylate and 2-ethylhexyl methacrylate; nitrogen-containing acryls such as dimethylaminoethyl methacrylate; vinyl nitriles such as acrylonitrile and methacrylonitrile; vinyl pyridines such as 2-vinylpyridine and 4-vinylpyridine; vinyl ethers such as vinyl methyl ether and vinyl isobutyl ether; vinyl ketones such as vinyl methyl ketone, vinyl ethyl ketone and vinyl isopropenyl ketone; olefins such as ethylene and propylene; fluorine-containing vinyl-based monomers such as vinylidene fluoride, tetrafluoroethylene and hexafluoroethylene, as well as silicone resins including methyl silicone and methylphenyl silicone, polyesters including bisphenol and glycol, epoxy resins, polyurethane resins, polyamide resins, cellulose resins, polyether resins, and polycarbonate resins. These resins may be used singly or in combination of two or more types. The amount of the coating resin to be coated is preferably from about 0.1 part by weight to about 10 parts by weight, and more preferably from 0.5 part by weight to 3.0 parts by weight with respect to 100 parts by weight of the nucleus particles.

The carrier is manufactured using, for example, a heating kneader, a heating Henschel mixer, a UM mixer, or the like. Depending on the amount of the coating resin, a heating fluidized bed, a heating kiln or the like is used.

A carrier that is formed by coating ferrite particles as nuclei with a resin in which carbon black as an electroconductive agent and/or melamine beads as a charge-controlling agent are dispersed in methyl acrylate or ethyl acrylate and styrene is preferably used as the carrier, because even when a thick coating layer is formed, excellent resistance controllability is obtained, and excellent image quality and image quality maintainability are thus obtained.

The mixing ratio of the toner and the carrier in the developer is not particularly limited and is selected in accordance with the purpose.

Image Forming Apparatus

Next, an image forming apparatus using the electrostatic charge image developing toner of this exemplary embodiment will be described.

An image forming apparatus of this exemplary embodiment has an image holding member, a charging section that charges the image holding member, an exposure section that exposes the charged image holding member to form an electrostatic latent image on a surface of the image holding member, a developing section that develops the electrostatic latent image with a developer including a toner to form a toner image, a transfer section that transfers the toner image onto a surface of a transfer member from the image holding member, and a fixing section that fixes the toner image transferred onto the surface of the transfer member, and the developer is the electrostatic charge image developing toner of this exemplary embodiment, or the electrostatic charge image developer of this exemplary embodiment.

In addition, the image forming apparatus has a cleaning section (toner remover) that scrubs the image holding member with a cleaning member to remove the residual components left after transfer, and uses the electrostatic charge image developer of this exemplary embodiment as the developer.

In the image forming apparatus, for example, a part including the developing section may be provided to have a cartridge structure (process cartridge) that is detachable from an image forming apparatus body. As the process cartridge, a process cartridge of this exemplary embodiment, that is provided with at least a developer holding member and accommodates the electrostatic charge image developer of this exemplary embodiment, is favorably used.

Hereinafter, an example of the image forming apparatus of this exemplary embodiment will be described. However, the invention is not limited thereto. Major parts shown in the drawing will be described, and descriptions of other parts will be omitted.

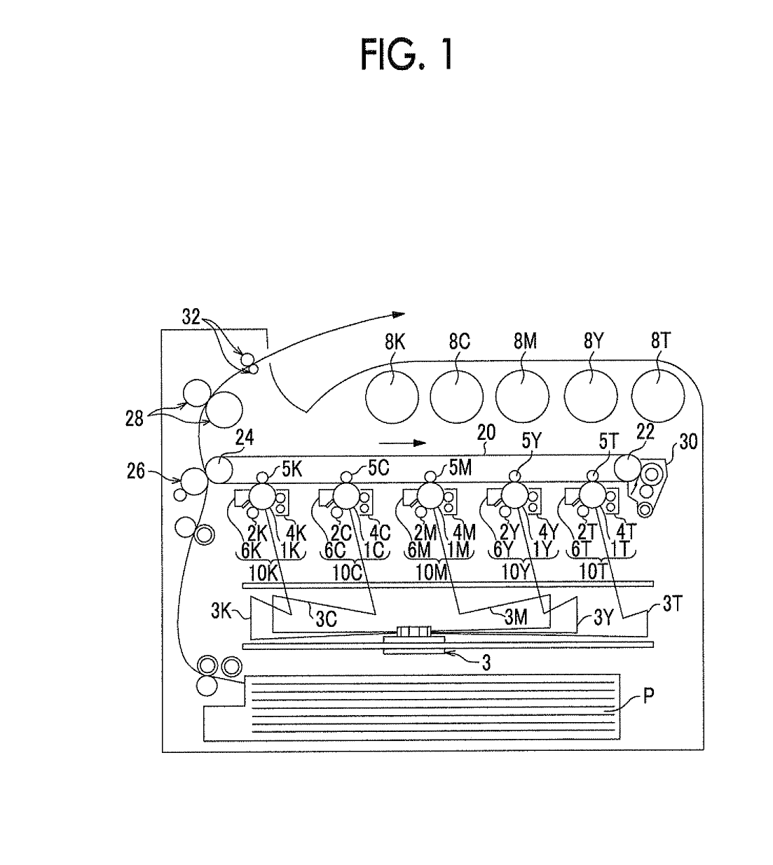

FIG. 1 is a schematic diagram showing the configuration of a 5-drum tandem full-color image forming apparatus. The image forming apparatus shown in FIG. 1 is provided with first to fifth electrophotographic image forming units 10Y, 10M, 10C, 10K, and 10T (image forming sections) that output a transparent (colorless) (T) image, a yellow (Y) image, a magenta (M) image, a cyan (C) image, and a black (K) image, respectively, based on color-separated image data. These image forming units (hereinafter, simply referred to as “units”) 10T, 10Y, 10M, 10C, and 10K are arranged in parallel and separated from each other in a horizontal direction. Each of the units 10T, 10Y, 10M, 10C and 10K may be a process cartridge that is detachable from the image forming apparatus body.

An intermediate transfer belt 20 as an intermediate transfer member is disposed above the units 10T, 10Y, 10M, 10C, and 10K in the drawing to extend through the units. The intermediate transfer belt 20 is wound on a driving roller 22 and a support roller 24 contacting the inner surface of the intermediate transfer belt 20, which are separated from each other on the left and right sides in the drawing, and travels in a direction toward the fifth unit 10K from the first unit 10T. The support roller 24 is impelled in a direction in which it departs from the driving roller 22 by a spring or the like (not shown), and a tension is given to the intermediate transfer belt 20 wound on both of the rollers. In addition, an intermediate transfer member cleaning device 30 opposed to the driving roller 22 is provided on a surface of the intermediate transfer belt 20 on the image holding member side.

Developing devices (developing sections) 4T, 4Y, 4M, 4C and 4K of the units 10T, 10Y, 10M, 10C and 10K are supplied with five toners, that is, a transparent toner, a yellow toner, a magenta toner, a cyan toner, and a black toner accommodated in toner cartridges 8T, 8Y, 8M, 8C and 8K, respectively.

The above-described first to fifth units 10T, 10Y, 10M, 10C, and 10K have the same configuration. Here, only the first unit 10T that is disposed on the upstream side in a traveling direction of the intermediate transfer belt to form a transparent image will be representatively described. The same parts as in the first unit 10T will be denoted by the reference numerals with yellow (Y), magenta (M), cyan (C), and black (K) added instead of transparent (T), and descriptions of the second to fifth units 10Y, 10M, 10C, and 10K will be omitted.

The first unit 10T has a photoreceptor 1T acting as an image holding member. Around the photoreceptor 1T, a charging roller 2T that charges a surface of the photoreceptor 1T, an exposure device 3 that exposes the charged surface with laser beams 3T based on a color-separated image signal to form an electrostatic latent image, a developing device (developing section) 4T that supplies a charged toner to the electrostatic latent image to develop the electrostatic latent image, a primary transfer roller (primary transfer section) 5T that transfers the developed toner image onto the intermediate transfer belt 20, and a photoreceptor cleaning device (cleaning section) 6T that removes the toner remaining on the surface of the photoreceptor 1T after primary transfer, are arranged in sequence.

The primary transfer roller 5T is disposed inside the intermediate transfer belt 20 to be provided at a position opposed to the photoreceptor 1T. Furthermore, bias supplies (not shown) that apply a primary transfer bias are connected to the primary transfer rollers 5T, 5Y, 5M, 5C, and 5K, respectively. The bias supplies change the transfer bias that is applied to each primary transfer roller under the control of a controller (not shown).

Hereinafter, an operation of forming a transparent image in the first unit 10T will be described. First, before the operation, the surface of the photoreceptor 1T is charged to a potential of from about −600 V to about −800 V by the charging roller 2T.

The photoreceptor 1T is formed by stacking a photosensitive layer on a conductive base (volume resistivity at 20° C.: 1×10⁻⁶ Ωcm or less). This photosensitive layer typically has high resistance (resistance that is about the same as the resistance of a general resin), but has a property in which when laser beams 3T are applied, the specific resistance of a part irradiated with the laser beams changes. Accordingly, the laser beams 3T are output to the surface of the charged photoreceptor 1T via the exposure device 3 in accordance with image data for transparency sent from the controller (not shown). The laser beams 3T are applied to the photosensitive layer on the surface of the photoreceptor 1T, whereby an electrostatic latent image of a transparent print pattern is formed on the surface of the photoreceptor 1T.

The electrostatic latent image is an image that is formed on the surface of the photoreceptor 1T by charging, and is a so-called negative latent image, that is formed by applying the laser beams 3T to the photosensitive layer so that the specific resistance of the irradiated part is lowered to cause charges to flow on the surface of the photoreceptor 1T and to cause charges to stay on a part to which the laser beams 3T are not applied.

The electrostatic latent image that is formed in this manner on the photoreceptor 1T is rotated up to a development position with the travelling of the photoreceptor 1T. The electrostatic latent image on the photoreceptor 1T is developed at the development position by the developing device 4T.

The developing device 4T accommodates a transparent toner of this exemplary embodiment. The transparent toner is frictionally charged by being stirred in the developing device 4T to have a charge with the same polarity (negative polarity) as the charge that is on the photoreceptor 1T, and is thus held on the developer roll (developer holding member). By allowing the surface of the photoreceptor 1T to pass through the developing device 4T, the transparent toner is electrostatically adhered to a latent image part having no charge on the surface of the photoreceptor 1T, whereby the latent image is developed with the transparent toner. Next, the photoreceptor 1T having a transparent toner image formed thereon continuously travels and the developed toner image on the photoreceptor 1T is transported to a primary transfer position.

When the transparent toner image on the photoreceptor 1T is transported to the primary transfer position, a primary transfer bias is applied to the primary transfer roller 5T and an electrostatic force toward the primary transfer roller 5T from the photoreceptor 1T acts on the toner image, whereby the toner image on the photoreceptor 1T is transferred onto the intermediate transfer belt 20. The transfer bias applied at this time has the opposite polarity (+) of the toner polarity (−), and is controlled to be, for example, about +10 μA in the first unit 10T by the controller (not shown).

On the other hand, the toner remaining on the photoreceptor 1T is removed by the photoreceptor cleaning device 6T and recovered.

The primary transfer biases that are applied to the primary transfer rollers 5Y, 5M, 5C, and 5K of the second unit 10Y and the subsequent units are also controlled in the same manner as in the case of the first unit.

In this manner, the intermediate transfer belt 20 onto which the transparent toner image is transferred in the first unit 10T is sequentially transported through the second to fifth units 10Y, 10M, 10C, and 10K, and the toner images of respective colors are multiply-transferred in a superimposed manner.

The intermediate transfer belt 20 onto which the five color toner images have been multiply-transferred through the first to fifth units reaches a secondary transfer part which includes the intermediate transfer belt 20, the support roller 24 contacting the inner surface of the intermediate transfer belt 20, and a secondary transfer roller (secondary transfer section) 26 disposed on the image holding surface side of the intermediate transfer belt 20. Meanwhile, a recording sheet (transfer member) P is supplied to a gap between the secondary transfer roller 26 and the intermediate transfer belt 20, which are pressed against each other, via a supply mechanism, and a secondary transfer bias is applied to the support roller 24. The transfer bias applied at this time has the same polarity (−) as the toner polarity (−), and an electrostatic force toward the recording sheet P from the intermediate transfer belt 20 acts on the toner image, whereby the toner image on the intermediate transfer belt 20 is transferred onto the recording sheet P. In this case, the secondary transfer bias is determined depending on the resistance detected by a resistance detector (not shown) that detects the resistance of the secondary transfer part, and is voltage-controlled.

Thereafter, the recording sheet P is fed to the fixing device (fixing section) 28, the toner image is heated, and the color-superimposed toner image is melted and fixed onto the recording sheet P. The recording sheet P on which the fixing of the color image is completed is transported toward a discharge part, and a series of the color image forming operations ends.

The image forming apparatus exemplified as above has a configuration in which the toner image is transferred onto the recording sheet P via the intermediate transfer belt 20. However, the invention is not limited to this configuration, and may have a structure in which the toner image is transferred directly onto the recording sheet from the photoreceptor.

Process Cartridge and Toner Cartridge

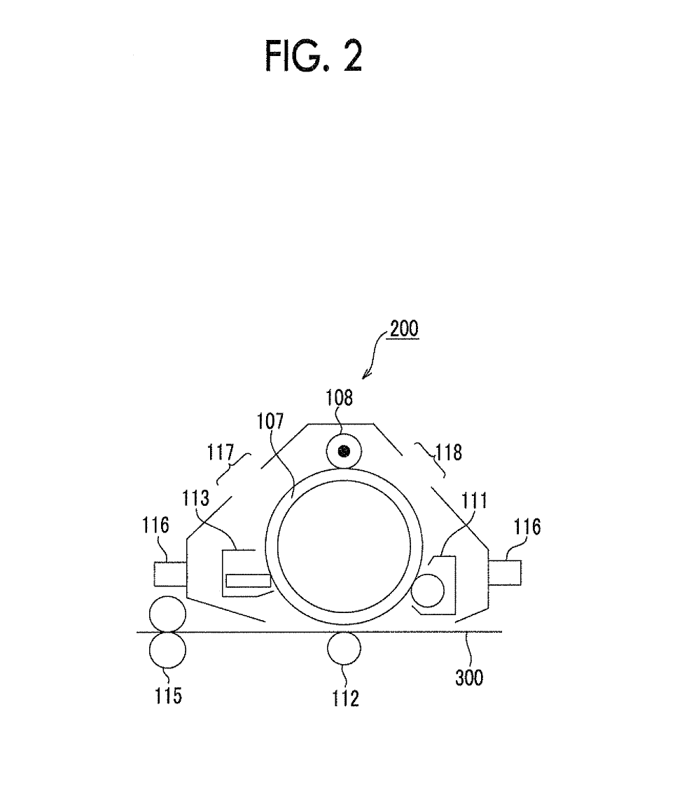

FIG. 2 is a schematic diagram showing the configuration of a favorable example of a process cartridge that accommodates the electrostatic charge image developer of this exemplary embodiment. A process cartridge 200 has, in addition to a photoreceptor 107, a charging roller 108, a developing device 111 provided with a developer holding member 111A, a photoreceptor cleaning device (cleaning section) 113, an opening 118 for exposure, and an opening 117 for erasing exposure, and they are combined and integrated using an attachment rail 116.

The process cartridge 200 is detachably mounted on an image forming apparatus body including a transfer device 112, a fixing device 115, and other constituent parts (not shown), and constitutes, together with the image forming apparatus body, an image forming apparatus that forms an image on a recording sheet 300.

The process cartridge shown in FIG. 2 includes the charging roller 108, the developing device 111, the cleaning device (cleaning section) 113, the opening 118 for exposure, and the opening 117 for erasing exposure, but these devices may be selectively combined. The process cartridge of this exemplary embodiment may include at least the developing device 111 provided with the developer holding member 111A and may include at least one selected from the group consisting of the photoreceptor 107, the charging device 108, the cleaning device (cleaning section) 113, the opening 118 for exposure, and the opening 117 for erasing exposure.

Next, a toner cartridge of this exemplary embodiment will be described. The toner cartridge is detachably mounted on an image forming apparatus, and at least in the toner cartridge that stores a toner to be supplied to a developing section provided in the image forming apparatus, the toner is the above-described toner of this exemplary embodiment. The toner cartridge of this exemplary embodiment may accommodate at least a toner, and depending on the mechanism of the image forming apparatus, may accommodate, for example, a developer.

Accordingly, in an image forming apparatus having a configuration in which a toner cartridge is detachably mounted, a toner cartridge that stores the toner of this exemplary embodiment is used to easily supply the toner of this exemplary embodiment to a developing device.

The image forming apparatus shown in FIG. 2 is an image forming apparatus that has a configuration in which the toner cartridges 8T, 8Y, 8M, 8C, and 8K are detachably mounted. The developing devices 4T, 4Y, 4M, 4C, and 4K are connected to the toner cartridges corresponding to the respective developing devices (colors) via toner supply tubes (not shown). In addition, when the toner stored in the toner cartridge runs low, the toner cartridge may be replaced.

Image Forming Method

Next, an image forming method using the toner of this exemplary embodiment will be described. The toner of this exemplary embodiment is used in a known image forming method using an electrophotographic system. Specifically, the toner is used in an image forming method having the following processes.

That is, a preferable image forming method includes: a latent image forming process of forming an electrostatic latent image on a surface of an image holding member, a developing process of developing the electrostatic latent image formed on the surface of the image holding member with a developer including a toner to form a toner image, a transfer process of transferring the toner image onto a surface of a transfer member, and a fixing process of fixing the toner image transferred onto the surface of the transfer member, and as the developer, the electrostatic charge image developing toner of this exemplary embodiment, or the electrostatic charge image developer of this exemplary embodiment is used. In addition, in the transfer process, an intermediate transfer member that mediates the transfer of the toner image onto the transfer member from the electrostatic latent image holding member may be used.

Toner Cartridge, Developer Cartridge, and Process Cartridge

The toner cartridge of this exemplary embodiment accommodates at least the electrostatic charge image developing toner of this exemplary embodiment.

The developer cartridge of this exemplary embodiment accommodates at least the electrostatic charge image developer of this exemplary embodiment.

In addition, the process cartridge of this exemplary embodiment is provided with a developing section that develops an electrostatic latent image formed on a surface of an image holding member with the electrostatic charge image developing toner or the electrostatic charge image developer to form a toner image, and at least one selected from the group consisting of the image holding member, a charging section for charging the surface of the image holding member, and a cleaning section for removing the toner remaining on the surface of the image holding member, and accommodates at least the electrostatic charge image developing toner of this exemplary embodiment, or the electrostatic charge image developer of this exemplary embodiment.

It is preferable that the toner cartridge of this exemplary embodiment may be detachable from an image forming apparatus. That is, the toner cartridge of this exemplary embodiment that stores the toner of this exemplary embodiment is preferably used in an image forming apparatus having a configuration in which the toner cartridge is detachable.

The developer cartridge of this exemplary embodiment is not particularly limited as long as it contains an electrostatic charge image developer including the electrostatic charge image developing toner of this exemplary embodiment. The developer cartridge is, for example, detachable from an image forming apparatus provided with a developing section, and stores an electrostatic charge image developer including the electrostatic charge image developing toner of this exemplary embodiment as a developer to be supplied to the developing section.

In addition, the developer cartridge may be a cartridge that stores a toner and a carrier, or may be divided into a cartridge storing a toner alone and a cartridge storing a carrier alone, that are separate members.

The process cartridge of this exemplary embodiment is preferably detachably mounted on an image forming apparatus.

In addition, the process cartridge of this exemplary embodiment may include other members such as an erasing section, if necessary.

The toner cartridge and the process cartridge may employ known configurations. For example, see JP-A-2008-209489 and JP-A-2008-233736.

### EXAMPLES

Hereinafter, this exemplary embodiment will be described in more detail with reference to examples and comparative examples, but is not limited to the examples.

In the following examples, unless specifically noted, “parts” represents “parts by weight” and “%” represents “% by weight”.

Measuring Methods

Method of Measuring Ultraviolet Absorption Spectrum

An absorption spectrum of a binder resin is measured using a U-3310 spectrophotometer (manufactured by Hitachi High-Technologies Corporation). As a measurement sample, a binder resin dissolved in acrylonitrile so as to be at 1,000 ppm is used, and a wavelength at which absorbance is greater than 2.0 with an optical path length of 1 cm under measurement conditions of a start wavelength of 500 nm, an end wavelength of 200 nm, a scanning speed of 300 nm/min, and a slit of 2 nm is defined as a rising wavelength in the absorption spectrum.

Method of Measuring Volume Average Particle Size

The volume average particle size of a toner is measured using a Coulter Multisizer II (manufactured by Beckman Coulter, Inc.). ISOTON-II (manufactured by Beckman Coulter, Inc.) is used as an electrolyte.

As a measuring method, first, 0.5 mg to 50 mg of a measurement sample is added to 2 ml of a surfactant as a dispersant, preferably a 5% aqueous solution of sodium alkylbenzene sulfonate. The resultant material is added to 100 ml to 150 ml of the electrolyte. The electrolyte in which the measurement sample is suspended is subjected to a dispersion treatment for about 1 minute by an ultrasonic dispersing machine, and the particle size distribution of particles having a particle size of 2.0 μm to 60 μm is measured by the Coulter Multisizer II with the use of an aperture having an aperture diameter of 100 μm. The number of particles to be measured is 50,000.

The measured particle size distribution is accumulated to draw a cumulative distribution from the smallest diameter side for the weight or volume with respect to divided particle size ranges (channels), and the particle size corresponding to 50% in accumulation is defined as a weight average particle size or a volume average particle size.

Method of Measuring Particle Size Distribution

A toner particle size distribution index is measured as follows. The above-described particle size distribution measured using the Coulter Multisizer II is divided into particle size ranges (channels), and with respect to these, a cumulative distribution is drawn from the smallest diameter side for the volume and number. The particle size corresponding to 16%-accumulation with regard to the volume is defined as D16v, the particle size corresponding to 16%-accumulation with regard to the number is defined as D16p, the particle size corresponding to 50%-accumulation with regard to the volume is defined as D50v, the particle size corresponding to 50%-accumulation with regard to the number is defined as D50p, the particle size corresponding to 84%-accumulation with regard to the volume is defined as D84v, and the particle size corresponding to 84%-accumulation with regard to the number is defined as D84p.

Using the measured values, an upper volume average particle size distribution index (upper GSDv) is calculated from (D84v/D50v)^{1/2}, and a lower number average particle size distribution index (lower GSDp) is calculated from (D50p/D16p)^{1/2}.

Preparation of Dispersions

First, dispersions that are used in the preparation of toner base particles are prepared as follows.

Preparation of Amorphous Polyester Resin Particle Dispersion A

Terephthalic Acid: 38 parts

Fumaric Acid: 40 parts

Bisphenol-A Propylene Oxide 2-mol Adduct: 60 parts

Bisphenol-A Ethylene Oxide 2-mol Adduct: 20 parts

The above-described components are put into a reaction container provided with a stirrer, a thermometer, a condenser, and a nitrogen gas introduction tube, and the air in the reaction container is substituted by a dry nitrogen gas. Thereafter, 0.5 parts of dibutyl tin oxide is added as a catalyst, and the materials are stirred and reacted for about 8 hours at about 190° C. under the nitrogen gas flow, and further stirred and reacted for about 6 hours at a temperature raised to about 240° C. Then, the pressure in the reaction container is reduced to 10.0 mmHg to stir and react the reactant for 0.5 hours under reduced pressure, thereby obtaining a resin A that is a transparent polyester.

Next, the obtained resin A is dispersed using a dispersing machine made by modifying a Cavitron CD1010 (manufactured by Eurotec, Inc.) to a high-temperature and high-pressure type. An amorphous polyester resin particle dispersion A containing polyester with a solid content of 20% is obtained by operating the Cavitron under conditions of a rotor rotation speed of 60 Hz, a pressure of 5 kg/cm², and heating to 140° C. by a heat exchanger with a composition ratio in which ion exchange water is 80% and the polyester resin concentration is 20% and a pH adjusted to 8.0 by ammonia.

The weight average molecular weight and the glass transition temperature of the obtained resin A and the volume average particle size of the resin particle dispersion A are shown in Table 1.

Preparation of Amorphous Polyester Resin Particle Dispersion B

An amorphous polyester resin particle dispersion B is prepared in the same manner as in the case of the amorphous polyester resin particle dispersion A, except that the amount of the terephthalic acid is changed from 38 parts to 53 parts and the amount of the fumaric acid is changed from 40 parts to 30 parts.

Preparation of Amorphous Polyester Resin Particle Dispersion C

An amorphous polyester resin particle dispersion C is prepared in the same manner as in the case of the amorphous polyester resin particle dispersion A, except that the amount of the terephthalic acid is changed from 38 parts to 16 parts and the amount of the fumaric acid is changed from 40 parts to 55 parts.

Preparation of Amorphous Polyester Resin Particle Dispersion D

An amorphous polyester resin particle dispersion D is prepared in the same manner as in the case of the amorphous polyester resin particle dispersion A, except that the amount of the terephthalic acid is changed from 38 parts to 74 parts and the amount of the fumaric acid is changed from 40 parts to 15 parts.

Preparation of Amorphous Polyester Resin Particle Dispersion E

An amorphous polyester resin particle dispersion E is prepared in the same manner as in the case of the amorphous polyester resin particle dispersion A, except that the amount of the terephthalic acid is changed from 38 parts to 0 part and the amount of the fumaric acid is changed from 40 parts to 67 parts.

TABLE 1

| | | | | Wavelength |
|---|---|---|---|---|
| | | | | at which |
| | | Glass | Volume | Absorbance |
| | | Transition | Average | is 2.0 or |
| | Weight Average | Temperature | Particle Size | Greater |
| | Molecular Weight | (° C.) | (nm) | (nm) |
| Resin A | 15,000 | 66 | 179 | 302 |
| Resin B | 20,000 | 61 | 170 | 281 |
| Resin C | 14,000 | 60 | 167 | 320 |
| Resin D | 24,000 | 58 | 160 | 270 |
| Resin E | 19,000 | 55 | 150 | 339 |

Preparation of Release Agent Dispersion A

Paraffin Wax HNP9 (melting temperature: 76° C., manufactured by Nippon Seiro Co., Ltd.): 60 parts

Ionic Surfactant (Neogen RK, manufactured by Dai-ichi Kogyo Seiyaku Co., Ltd.): 5 parts

Ion Exchange Water: 240 parts

A solution obtained by mixing the above components is heated to 95° C. and sufficiently dispersed using an Ultra Turrax T50 (manufactured by IKA), and then subjected to a dispersion treatment by a pressure discharge-type Gaulin homogenizer, thereby obtaining a release agent dispersion A having a volume average particle size of 220 nm with a solid content of 20% by weight.

Preparation of Fluorescent Material Dispersion A

CARTAX CXDP POWDER (compound represented by Formula (1), manufactured by Clariant): 50 parts

Ionic Surfactant (Neogen RK, manufactured by Dai-ichi Kogyo Seiyaku Co., Ltd.): 5 parts

Ion Exchange Water: 200 parts

A solution obtained by mixing the above components is pre-dispersed for 5 minutes by ultrasonic dispersion, and then transferred to a cylindrical container. Then, dispersion is performed for 24 hours by a bead mill filled with 1.0 mm-zirconia beads, thereby obtaining a fluorescent material dispersion A having a volume average particle size of 280 nm.

Preparation of Toner of Two-Component Developer

Preparation of Transparent Toner Base Particles T1

Amorphous Polyester Resin Particle Dispersion A: 370 parts

Release Agent Dispersion A: 100 parts

Fluorescent Material Dispersion A: 30 parts

While the above components are stirred with 550 parts by weight of ion exchange water in a round flask made of stainless steel, the temperature is adjusted to 20° C. Thereafter, the resultant material is sufficiently mixed and dispersed by an Ultra Turrax T50.

Next, 150 parts by weight of an aqueous aluminum sulfate solution (equivalent to Al₂(SO₃)₄, 15 parts by weight) is added thereto and the dispersion operation is continued by the Ultra Turrax. Thereafter, the flask is heated to 45° C. at a speed of 1° C./5 min while stirring by an oil bath for heating, and held as is for 20 minutes. Thereafter, the pH in the system is adjusted to 7.5 by a 1 mol/L-aqueous sodium hydroxide solution, and then the flask made of stainless steel is sealed and heated to 90° C. while the stirring is continued using a magnetic seal, and the resultant material is left while being stirred for 2 hours at 90° C. Thereafter, a multitubular heat exchanger is used (heat medium: cold water at 5° C.), the flow rate is adjusted to obtain a cooling rate of 30° C./min, and rapid cooling to 30° C. is performed. Thereafter, filtration is performed, washing is sufficiently performed with ion exchange water and solid-liquid separation is performed by Nutsche suction filtration. Re-dispersion is performed with ion exchange water at 30° C., and stirring and washing are performed for 15 minutes at 300 rpm.

This operation is repeated 5 times, and when the electric conductivity of the filtrate is 15 μS/cm or less, solid-liquid separation is performed using No. 5A filter paper by Nutsche suction filtration. Next, vacuum drying is continued for 12 hours.

At this time, when the particle size is measured by a Coulter counter, the volume average particle size is 5.4 μm. The upper volume average particle size distribution index upper GSDv is 1.19, the lower number average particle size distribution index lower GSDp is 1.23, and the shape factor SF1 is 134.

Preparation of Transparent Toner Base Particles T2

Transparent toner base particles T2 are obtained in the same manner as in the case of the transparent toner base particles T1, except that the amorphous polyester resin particle dispersion A is changed to the amorphous polyester resin particle dispersion B.

At this time, when the particle size is measured by a Coulter counter, the volume average particle size is 5.6 μm. The upper volume average particle size distribution index upper GSDv is 1.23, the lower number average particle size distribution index lower GSDp is 1.22, and the shape factor SF1 is 135.

Preparation of Transparent Toner Base Particles T3

Transparent toner base particles T3 are obtained in the same manner as in the case of the transparent toner base particles T1, except that the amorphous polyester resin particle dispersion A is changed to the amorphous polyester resin particle dispersion C.

At this time, when the particle size is measured by a Coulter counter, the volume average particle size is 5.4 μm. The upper volume average particle size distribution index upper GSDv is 1.24, the lower number average particle size distribution index lower GSDp is 1.25, and the shape factor SF1 is 130.

Preparation of Transparent Toner Base Particles T4

Polyester Resin A: 420 parts

CARTAX CXDP POWDER (compound represented by Formula (1), manufactured by Clariant): 30 parts

Polyethylene Wax 400P (manufactured by Mitsui Chemicals, Inc.): 50 parts

The above-described components are mixed in a powdery state by a Henschel mixer, and the mixture is subjected to thermal kneading by a biaxial extruder (setting temperature: 110° C.) and cooled. Then, transparent toner base particles T4 are obtained through coarse pulverization by a hammer mill, fine pulverization by a jet mill, and classification by an airflow classifier.

At this time, when the particle size is measured by a Coulter counter, the volume average particle size is 8.0 μm. The upper volume average particle size distribution index upper GSDv is 1.30, the lower number average particle size distribution index lower GSDp is 1.29, and the shape factor SF1 is 145.

Preparation of Transparent Toner Base Particles T5

Transparent toner base particles T5 are obtained in the same manner as in the case of the transparent toner base particles T1, except that the amorphous polyester resin particle dispersion A is changed to the amorphous polyester resin particle dispersion D.

At this time, when the particle size is measured by a Coulter counter, the volume average particle size is 5.8 μm. The upper volume average particle size distribution index upper GSDv is 1.23, the lower number average particle size distribution index lower GSDp is 1.21, and the shape factor SF1 is 131.

Preparation of Transparent Toner Base Particles T6

Transparent toner base particles T6 are obtained in the same manner as in the case of the transparent toner base particles T1, except that the amorphous polyester resin particle dispersion A is changed to the amorphous polyester resin particle dispersion E.

At this time, when the particle size is measured by a Coulter counter, the volume average particle size is 5.9 μm. The upper volume average particle size distribution index upper GSDv is 1.20, the lower number average particle size distribution index lower GSDp is 1.21, and the shape factor SF1 is 131.

Preparation of Fluorescent Material Dispersion B

Coumarin (manufactured by Wako Pure Chemical Industries, Ltd., special grade reagent): 20 parts

Amorphous Polyester Resin A: 80 parts The above components are kneaded by a Banbury mixer to obtain a master batch. Next, the obtained master batch is dispersed using a dispersing machine made by modifying a Cavitron CD1010 (manufactured by Eurotec, Inc.) to a high-temperature and high-pressure type. A fluorescent material dispersion B containing a fluorescent material with a solid content of 20% in amorphous polyester is obtained by operating the Cavitron under conditions of a rotor rotation speed of 60 Hz, a pressure of 5 kg/cm², and heating to 140° C. by a heat exchanger with a composition ratio in which ion exchange water is 80% and the polyester resin concentration is 20% and a pH adjusted to 8.0 by ammonia.

Preparation of Transparent Toner Base Particles T7

Transparent toner base particles T7 are obtained in the same manner as in the case of the transparent toner base particles T1, except that the amount of the amorphous polyester resin particle dispersion A is changed from 370 parts to 250 parts and 30 parts of the fluorescent material dispersion A is changed to 150 parts of the fluorescent material dispersion B.

At this time, when the particle size is measured by a Coulter counter, the volume average particle size is 6.0 μm. The upper volume average particle size distribution index upper GSDv is 1.25, the lower number average particle size distribution index lower GSDp is 1.24, and the shape factor SF1 is 135.

Preparation of Transparent Toner Base Particles T8

Transparent toner base particles T8 are obtained in the same manner as in the case of the transparent toner base particles T1, except that the amount of the amorphous polyester resin particle dispersion A is changed from 370 parts to 390 parts and the amount of the fluorescent material dispersion A is changed from 30 parts to 10 parts.

At this time, when the particle size is measured by a Coulter counter, the volume average particle size is 5.5 μm. The upper volume average particle size distribution index upper GSDv is 1.22, the lower number average particle size distribution index lower GSDp is 1.22, and the shape factor SF1 is 132.

Preparation of Transparent Toner Base Particles T9

Transparent toner base particles T9 are obtained in the same manner as in the case of the transparent toner base particles T1, except that the amount of the amorphous polyester resin particle dispersion A is changed from 370 parts to 350 parts and the amount of the fluorescent material dispersion A is changed from 30 parts to 50 parts.

At this time, when the particle size is measured by a Coulter counter, the volume average particle size is 5.8 μm. The upper volume average particle size distribution index upper GSDv is 1.21, the lower number average particle size distribution index lower GSDp is 1.25, and the shape factor SF1 is 130.

Addition of External Additive

As external additives, 0.5 part of titania treated with decyltrimethoxysilane having a volume average particle size of 30 nm and 0.9 part of silica treated with hexamethyldisilazane having a volume average particle size of 100 nm are added to transparent toner base particles T1 to T11 prepared as described above per 100 parts of the toner base particles, mixed for 10 minutes by a Henschel mixer (manufactured by Mitsui Miike Chemical Engineering Machinery, Co., Ltd.), and sieved by an air classifier Hibolter NR300 (manufactured by Tokyo Kikai Seisakusho, Ltd.) (screen opening: 45 μm), thereby obtaining transparent toners T1 to T11.

Preparation of Developer

Ferrite cores having a particle size of 40 μm are coated with a silicone resin (manufactured by Dow Corning Toray Silicone Co., LTd., SR2411) of 0.8% by weight in terms of weight ratio using a kneader device, thereby obtaining a carrier 1. 92 parts by weight of the obtained carrier 1 and 8 parts of the above-described transparent toners T1 to T11 are mixed, respectively, by a V-blender, thereby obtaining developers T1 to T11.

Evaluation Methods

Image Emission Intensity

A prepared transparent toner developer is injected into a fifth engine of a modified Color 1000 Press manufactured by Fuji Xerox Co., Ltd. to form a print image by the transparent toner. As the image, a solid transparent toner image of 5 cm×5 cm is output so that a toner amount becomes 4.5 g/m².

Using a spectrophotofluorometer F-4500 (manufactured by Hitachi High-Technologies Corporation), the image emission intensity of the image after fixing is measured. The measurement conditions are as follows. The excitation wavelength is 365 nm, the fluorescence start wavelength is 400 nm, the fluorescence end wavelength is 600 nm, a scan speed is 240 nm/min, slits on the excitation side and the fluorescence side are 1 nm, and a photomultiplier voltage is 700 V.

A peak value of the emission intensity of the fluorescence measured under the conditions is read out, and an average of values measured at 5 points (center and 4 corners) in the solid image is defined as an image emission intensity. The image emission intensity is evaluated with the following standards.

A: The emission intensity is 1,200 or greater.

B: The emission intensity is 800 or greater and less than 1,200.

C: The emission intensity is 400 or greater and less than 800.

D: The emission intensity is less than 400.

Light Fastness

The solid image used in the measurement of the image emission intensity is irradiated with light under predetermined light emission conditions (light source: xenon lamp, filter: glass coated with quartz, light amount (average): about 60 W/m² in an ultraviolet wavelength region of 300 nm to 400 nm, irradiation time: 960 hours).

A Suntester CPS+ (manufactured by Atlas) is used as a test device. The image emission intensity of the solid image after light irradiation is measured, and a residual ratio is evaluated as light fastness with the following standards.

A: The residual ratio of the emission intensity is 0.9 or greater.

B: The residual ratio of the emission intensity is 0.8 or greater and less than 0.9.

C: The residual ratio of the emission intensity is 0.5 or greater and less than 0.8.

D: The residual ratio of the emission intensity is less than 0.5.

The results are shown in the following Table 2.

TABLE 2

| | | | | | Wavelength at | | | | |
|---|---|---|---|---|---|---|---|---|---|
| | | | | Amorphous | which Absorbance | Image | | | |
| | | Preparation | Fluorescence | Polyester | is 2.0 or Greater | Emission | | Light | |
| | Developer | Method | Species | Resin Type | (nm) | Intensity | | Fastness | |
| Example 1 | T1 | Aggregation | A | A | 302 | 1,550 | A | 0.95 | A |
| | | Unification | | | | | | | |
| Example 2 | T2 | Aggregation | A | B | 281 | 1,590 | A | 0.81 | B |
| | | Unification | | | | | | | |
| Example 3 | T3 | Aggregation | A | C | 320 | 1,100 | B | 0.91 | A |
| | | Unification | | | | | | | |
| Example 4 | T4 | Kneading | A | A | 302 | 1,220 | A | 0.89 | B |
| | | Pulverization | | | | | | | |
| Example 5 | T5 | Aggregation | A | D | 270 | 1,550 | A | 0.72 | C |
| | | Unification | | | | | | | |
| Example 6 | T6 | Aggregation | A | E | 339 | 620 | C | 0.86 | B |
| | | Unification | | | | | | | |
| Comparative | T7 | Aggregation | B | A | 302 | 560 | C | 0.24 | D |
| Example 1 | | Unification | | | | | | | |
| Example 7 | T8 | Aggregation | A | A | 302 | 550 | C | 0.92 | A |
| | | Unification | | | | | | | |
| Example 8 | T9 | Aggregation | A | A | 302 | 1,240 | A | 0.64 | C |
| | | Unification | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transparent electrostatic charge image developing toner comprising:
a binder resin; and
a compound represented by the following Formula (1):

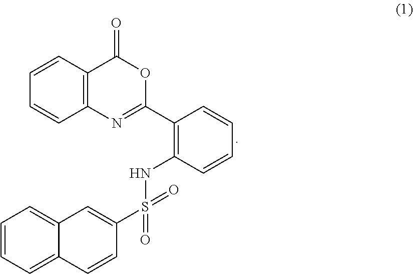 [SMILES: O=c1oc(-c2ccccc2NS(=O)(=O)c2ccc3ccccc3c2)nc2ccccc12]

2. The transparent electrostatic charge image developing toner according to claim 1, that has ultraviolet absorptivity.

3. The transparent electrostatic charge image developing toner according to claim 1,
wherein the binder resin contains a polyester resin in which a wavelength at which absorbance is 2.0 or greater in scanning from a long wavelength to a short wavelength in an ultraviolet absorption spectrum is from 280 nm to 320 nm.

4. The transparent electrostatic charge image developing toner according to claim 2,
wherein the binder resin contains a polyester resin in which a wavelength at which absorbance is 2.0 or greater in scanning from a long wavelength to a short wavelength in an ultraviolet absorption spectrum is from 280 nm to 320 nm.

5. The transparent electrostatic charge image developing toner according to claim 1,
wherein a content of the compound represented by Formula (1) in the toner is 2% by weight to 10% by weight.

6. The transparent electrostatic charge image developing toner according to claim 2,
wherein a content of the compound represented by Formula (1) in the toner is 2% by weight to 10% by weight.

7. The transparent electrostatic charge image developing toner according to claim 3,
wherein a content of the compound represented by Formula (1) in the toner is 2% by weight to 10% by weight.

8. The transparent electrostatic charge image developing toner according to claim 4,
wherein a content of the compound represented by Formula (1) in the toner is 2% by weight to 10% by weight.

9. An electrostatic charge image developer comprising:
the transparent electrostatic charge image developing toner according to claim 1; and
a carrier.

10. A toner cartridge that is detachable from an image forming apparatus and accommodates the transparent electrostatic charge image developing toner according to claim 1.

11. A developer cartridge that accommodates the electrostatic charge image developer according to claim 9.

12. A process cartridge that accommodates the electrostatic charge image developer according to claim 9, comprising:
a developer holding member that holds and transports the electrostatic charge image developer.

13. An image forming apparatus comprising:
an image holding member;
a charging section that charges an image holding member;
an exposure section that exposes a charged image holding member to form an electrostatic latent image on a surface of the image holding member;
a developing section that develops the electrostatic latent image with a developer including a toner to form a toner image;
a transfer section that transfers the toner image onto a surface of a transfer member from the image holding member; and
a fixing section that fixes the toner image transferred onto the surface of the transfer member,
wherein the developer is the transparent electrostatic charge image developing toner according to claim 1.

14. An image forming method comprising:
forming an electrostatic latent image on a surface of an image holding member;
developing the electrostatic latent image formed on the surface of the image holding member with a developer including a toner to form a toner image;
transferring the toner image onto a surface of a transfer member; and
fixing toner image transferred onto the surface of the transfer member,
wherein the developer is the transparent electrostatic charge image developing toner according to claim 1.

15. An image forming apparatus comprising:
an image holding member;
a charging section that charges an image holding member;
an exposure section that exposes a charged image holding member to form an electrostatic latent image on a surface of the image holding member;
a developing section that develops the electrostatic latent image with a developer including a toner to form a toner image;
a transfer section that transfers the toner image onto a surface of a transfer member from the image holding member; and
a fixing section that fixes the toner image transferred onto the surface of the transfer member,
wherein the developer is the electrostatic charge image developer according to claim 9.

16. An image forming method comprising:
forming an electrostatic latent image on a surface of an image holding member;
developing the electrostatic latent image formed on the surface of the image holding member with a developer including a toner to form a toner image;
transferring the toner image onto a surface of a transfer member; and
fixing toner image transferred onto the surface of the transfer member,
wherein the developer is the electrostatic charge image developer according to claim 9.
